(19) United States
(12) Patent Application Publication
(10) Pub. No.: US 2024/0299245 A1
(43) Pub. Date: Sep. 12, 2024

(54) Multiple Site Facial Stimulation Device and Methods

(71) Applicants: William Joseph Drasler, Minnetonka, MN (US); Mary Catherine Drasler, Minnetonka, MN (US); Diane Kay Wakat, Charlottesville, VA (US)

(72) Inventors: William Joseph Drasler, Minnetonka, MN (US); Mary Catherine Drasler, Minnetonka, MN (US); Diane Kay Wakat, Charlottesville, VA (US)

(21) Appl. No.: 18/594,067

(22) Filed: Mar. 4, 2024

Related U.S. Application Data
(60) Provisional application No. 63/451,597, filed on Mar. 12, 2023.

(51) Int. Cl. A61H 39/04

(52) U.S. Cl. CPC A61H 39/04; A61H 2201/10; A61H 2201/1607; A61H 2201/1652; A61H 2205/022

(57) ABSTRACT

A stimulation device for stimulating multiple stimulation sites on the face simultaneously. A device frame holds protruding posts into contact with the stimulation sites and a normal force is applied to all the stimulation sites. The protruding posts can have magnets attached to contact the stimulation site and provide stimulation alone or with normal forces. The protruding posts are adjustable to fit all facial configurations.

### CROSS REFERENCE TO RELATED APPLICATIONS

This patent application makes reference to and thereby incorporates all information found in the provisional patent application numbered: 63/451,597 entitled Multiple Site Facial Stimulation Device and Methods filed 12 Mar. 2023 by William J. Drasler, et. al.

### BACKGROUND OF THE INVENTION

### Acupuncture:

Acupuncture involves advancing a needle into the skin at a specific stimulation site such as a nerve or nerve ganglion to provide a neurological treatment for pain or dysfunction of internal organs of the body, for example. The needle must be sterile and advanced under the care of a treatment specialist; acupuncture is not well suited to be performed by an untrained individual in his home.

### Acupressure:

Acupressure is a technique whereby digital pressure is applied to the skin above a specific stimulation site to achieve a reduction in pain, improved blood flow, or other physiological benefit to the patient. The pressure is typically applied over a single site for a period of seconds or about a minute.

### Electrical Stimulation:

Application of an electrical signal to stimulation site can cause a change in an action potential of a nerve resulting in reduction of pain or provide a physiological benefit.

Claude describes in U.S. Pat. No. 10,596,374 the delivery of low amplitude current to nerve stimulation sites near the nose and eye to treat sinus disorders, colds, allergies and inflammation. A biphasic electrode is placed at a specific site and activated for a time of 2-10 seconds. The system requires that current be delivered to a stimulation site via a controlled electrical device prior to moving to a second stimulation site.

Rigaux describes in U.S. Pat. No. 10,773,080 a device for treatment of migraine headache. An electrical probe delivers a controlled current to a single stimulation site, the trigeminal nerve, located in the forehead of a patient. Application of a biphasic current pulse from an electrical device for a time period of at least 10 minutes to this single stimulation site is required to obtain relief from the migraine headache.

### Multi-Site Acupressure Stimulation:

Ceyhan (Altern Ther Health Med, 2019 January; 25(1)) has shown that acupressure applied simultaneously to multiple stimulation sites along the linear shape of the spine can achieve a reduction in atrial fibrillation in patients. Such simultaneous application of pressure at multiple stimulation sites has not been applied to stimulation sites on the complex contours of a person's face to achieve a benefit of improved blood flow, improved muscle relaxation, improved lymphatic drainage, nerve stimulation, improved drainage of sinus cavities, and improved inspiration capability through the nasal passages; many of these facial stimulation site benefits are not present when stimulating other parts of the body including spinal stimulation.

### Mechanical Nasal Passage Opening:

Several devices have been disclosed in the patent literature for opening nasal passages in order to provide improved inspiration capability to the patient especially during sleeping. These devices are directed at mechanically placing a force onto a wall of the nasal passage to directly move the nasal passage wall to an open configuration.

Doubek discloses in U.S. Pat. No. 5,533,503 a device that holds nasal passages open via a flat strip that is adhered to the outside skin of the nose; the strip has an outward bias to pull outwards on the skin of the nose to maintain the nasal passages in an open configuration. The use of an adhesive to pull on the skin of the nose can cause sloughing of the nasal skin cells causing irritation and inflammation.

What is needed is a device that can treat multiple stimulation sites along the complex contours of the face simultaneously to improve blood flow, relax the underlying muscle, increase lymphatic drainage, reduce the presence of pain, stimulate the nerve, reduce sinus congestion, or in a physiological manner improve the inhalation capability of the patient. The device should not require an adhesive to be applied to the patient's skin and the potential for skin abrasion and irritation. The device should be safe and easy to use and hence should not involve the delivery of an electrical current from an electrical device. The device should provide the benefits of treating multiple stimulation sites simultaneously for a few minutes but obtain a benefit that lasts for a longer period up to several hours or treating the stimulation sites for longer time periods including overnight treatment to provide increased benefits including improved breathing and restful sleep.

### SUMMARY

The present invention is a stimulation device that is able to stimulate multiple sites on the complex contours of the face simultaneously to provide benefits to the patient. Simultaneous stimulation of stimulation sites of the face can help to drain sinus cavities, reduce the presence of pain, improve lymphatic drainage, relax muscles at the stimulation site, stimulate nerves near the stimulation site, or help open nasal passages for inspiration of air during breathing. These patient benefits can be enhanced by stimulating more than one site at a time; blood flow and muscle relaxation at one site can affect blood flow and muscle relaxation at a neighboring stimulation site. Drainage of a sinus cavities can be enhanced by opening up additional pathways for fluid drainage in neighboring sinus cavities, for example. Hence, a benefit can exist for stimulating multiple stimulation sites simultaneously.

The stimulation device of the present invention provides two or more protruding posts (up to 12 protruding posts) that are designed to make contact with the stimulation sites of the face at the same time. The posts of the stimulation device make contact with stimulation site locations at the surface of the patient's facial but the stimulation site also is found below the surface of the skin where stimulation occurs to stimulate nerves, muscles, blood vessels, and lymphatic vessels that are located below the surface of the patient's facial skin. The device allows the patient to set the contact of the posts against the stimulation sites of the face initially without any pressure or normal force being placed onto the stimulation sites. The patient can then apply a normal force (i.e., perpendicular to the patient's face or skin) via the stimulation device to transmit the normal force to each of the stimulation sites simultaneously. The normal force can be applied for several minutes to attain a benefit that is able to last for significantly longer periods of time. The stimulation device can also be strapped onto the patient's head and worn during sleep to provide multiple site stimulation overnight.

In another embodiment magnets can be place onto the ends of the protruding posts such that the magnets make contact with the stimulation sites of the face. The magnets are initially set to make contact with all of the stimulation sites of the patient's face simultaneously without any pressure or normal force being applied to the patient's face. Stimulation of the multiple stimulation sites can, in one method, occur without pressure or normal force being applied from the magnets to the stimulation sites. Alternately, a pressure or normal force can be applied to the stimulation device to place a normal force onto each of the magnets and transmit this normal force to the patient's face. The patient then can receive a benefit associated with both a pressure stimulation and also additional benefit due to the presence of the magnetic field provided by the magnets.

The magnets provide a magnetic flux that extends below the surface of the patient's face and can enhance blood flow leading to muscle relaxation. The muscle relaxation can help to relieve the presence of pain. The magnetic flux can also influence nerve activity that also can reduce patient pain. The magnetic flux can additionally assist in nasal cavity drainage via an affect of blood flow and nerve stimulation and can result in improved inspiration of air during breathing. The presence of the magnets can allow a more effective stimulation while applying a lower normal force to the stimulation site.

The stimulation device of the present invention can accommodate various shape of patient's faces to allow the protruding posts to make contact with stimulation sites of the face regardless of the size and shape or contour of a person's face. In one embodiment, the protruding posts are threaded posts that extend perpendicular to the surface of the frame of the stimulation device. In another embodiment the protruding posts extend at a fixed angle from the surface of the frame. In yet another embodiment the protruding posts are designed to angulate in any direction via a ball and socket design. The present invention allows all stimulation sites of the face to be stimulated simultaneously regardless of the width, length, or contour of the patient's face.

### BRIEF DESCRIPTION OF THE DRAWINGS

FIG. 1A is a side view of a patient's head having a frame of a stimulation device with multiple posts and post tips making contact with multiple stimulation sites of the face.

FIG. 1B is a frontal view of a patient's face having a frame of a stimulation device with multiple posts and post tips making contact with seven stimulation sites of the face.

FIG. 1C is a frontal view of a patient's face having a frame of a stimulation device with multiple posts and post tips making contact with two stimulation sites of the face.

FIG. 1D is a plan frontal view a stimulation device having seven frame stimulation site regions; each region having a ball and socket configuration to allow threaded posts to angulate or rotate in any direction.

FIG. 1E is a side view of a frame of a stimulation device showing a ball and socket assembly with a threaded post extending through a threaded hole in a spherical ball that rotates within a socket.

FIG. 1F is an end view of a frame of a stimulation device showing a ball and socket assembly and a set screw holding the spherical ball from rotating within the socket.

FIG. 2A is a side view of a patient's head with a stimulation device held in place by two straps.

FIG. 2B is a frontal view of the stimulation device being held to the patient's face via two straps and showing the nose cut-out that helps to position the stimulation device.

FIG. 2C is frontal view of the stimulation device being placed into contact with two stimulation sites on the patient's face; the stimulation device is held in place by a placement strap.

FIG. 3 is a side view of the stimulation device held against the patient's face via a normal force provided by the patient's hand; the posts have magnets at their ends and the magnets make contact with the stimulation sites on the patient's face.

### DETAILED DESCRIPTION

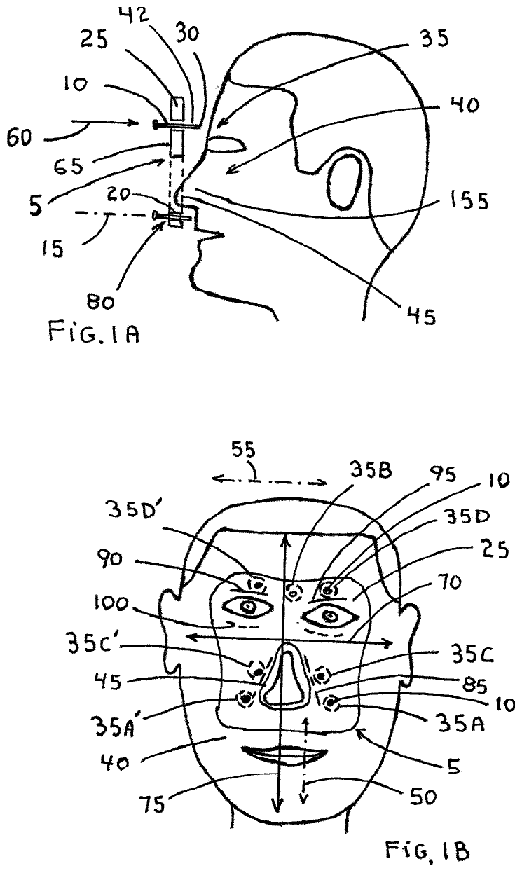

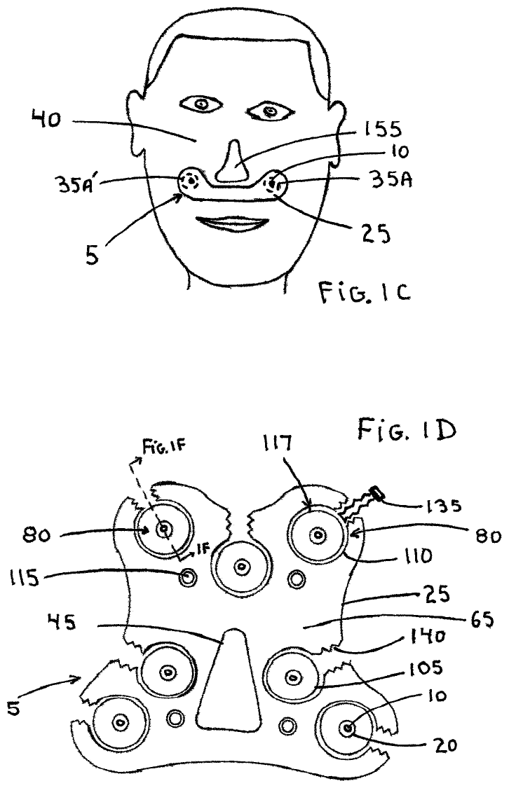

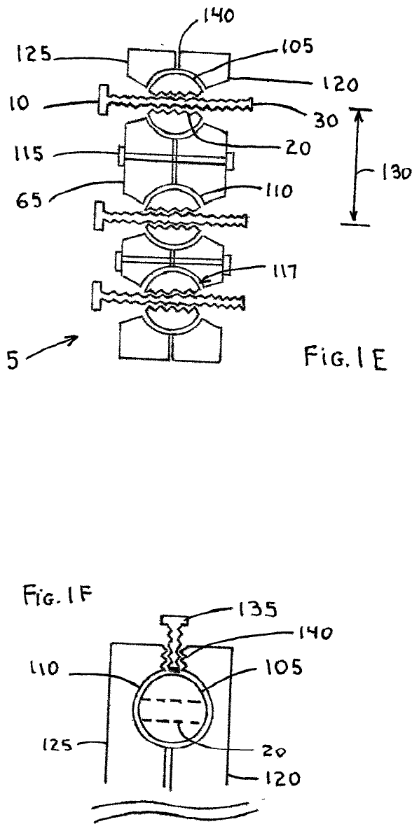

FIGS. 1A, 1B, and 1C show one embodiment of a hand-held stimulation device 5 with adjustable threaded posts 10 in an axial direction 15, for example, held via a screw-type mechanism into threaded post holes 20, for example, in a frame 25 to allow post tips 30 to make axial contact with stimulation sites 35 on the contours of a patient's face 40 and effectively stimulate nerves, vessels and tissues located below the surface of patient's skin. The threaded post 10 thereby provides a variable post extension 42 that accommodates the variable contours and shapes of the patient's face 40 via a threaded rotational motion. The frame 25 has a nose cut-out 45 or open space that provides placement for a nose 155 of a patient and locates the post tips 30 of the posts 10 adjacent to stimulation sites 35 on the face 40. The nose cut-out 45 positions the frame 25 in a longitudinal direction 50 on the face 40 and in a lateral direction 55 on the face 40 to place the tips directly adjacent to each of the stimulation sites 35. The tips can be adjusted by the patient to make initial contact with the multiple stimulation sites 35 (range 2-12 sites) of the face 40 at the same time without any normal force 60 being applied to the patient's facial skin. The patient can then apply hand pressure to the frame 25 to apply a normal force 60 (parallel to said post axial direction 15 or perpendicular to the facial skin of the patient or perpendicular to a frame frontal surface 65) toward the multiple stimulation sites 35 simultaneously. The threaded post holes 20 (and hence the threaded posts 10) can be angled relative to the frontal surface 65 of the frame 25 with lateral componency in a lateral direction 55 (in the direction of the patient's facial width 70) or in a longitudinal direction 50 (in the direction of the patient's facial length 75) to accommodate various facial widths 70 and facial lengths 75 and their corresponding locations of stimulation sites 35. The treaded posts 10 can alternately be directed perpendicular to the frame frontal surface 65 and allow the posts to be directed in an axial direction 15 to meet the contours of the face 40. FIG. 1B shows the stimulation device 5 having a frame 25 that makes simultaneous contact with seven stimulation sites, 35A, 35A′, 35B, 35C, 35C′, 35D, and 35D′ as described below; FIG. 1C shows a frame 25 that makes simultaneous contact with only two stimulation sites, sites 35A and 35A′, for example, as described below.

The pressure or normal force 60 applied by the tips to each stimulation site for an effective stimulation can be about 8 Oz (range 3-16 Oz) and can be applied for a period of about 1-3 minutes. The application of pressure to the multiple stimulation sites 35 can cause an increase in blood flow, affect nerve activity, improve lymphatic drainage, relax the muscles at the stimulation site, reduce the presence of pain, or help in a physiological manner to provide a more open nasal passage for inspiration of air during breathing and enhance sinus drainage. The benefits of the simultaneous stimulation pressure can be observed by the patient for periods of up to hours (range 30 minutes to 8 hours).

Seven frame stimulation site regions 80 configured for stimulation of multiple stimulation sites 35 (i.e., 35A, 35A′, 35B, 35C, 35C′, 35D, and 35D′, for example) are shown in FIG. 1A although it is understood that additional, or fewer, stimulations sites 35 can be identified and stimulated simultaneously without deviating from the present invention.

Stimulation sites 35A and 35A′ are located near the Nasolabial groove 85 or bilaterally adjacent to the lower limit of the nose. Stimulation of these two stimulation sites, 35A and 35A′, (left and right side) can positively influence muscle relaxation, circulatory flow, and lymphatic flow thereby improving nasal congestion and inhalation restriction.
Stimulation site 35B is located midway between the two eyebrows 90. Stimulation of this stimulation site, 35B, can positively affect nasal conditions, nasal restriction, or headache.
Stimulation sites 35C and 35C′ are located in the depression at the infraorbital opening 100 near the medial third of the eye orbit just inferior to the maxilla. Stimulation of these two stimulation sites (right and left) can reduce facial pain, sinus congestion, and headache. The stimulation sites 35C and 35C′can act as triggers for underlying muscle which can cause facial pain below the eye and along the forehead and thus stimulation of these sites will promote muscle relaxation and decrease pain and congestion. The stimulation sites 35C and 35C′can be responsible for allergy symptoms including sinus pain and headaches. Stimulation sites 35D and 35D′ are located in the eyebrow depression 95 near the medial end of the eyebrow 90; stimulation of these sites can decrease headache and pain.

The frame 25 can be molded from a plastic material such as an acrylic, polycarbonate, or other plastic suitable for external medical devices; the plastic should be able to hold the forces that are transmitted to the posts 10. Other materials for the frame 25 include metals, wood, and composites. The posts 10 can be formed from a threaded member such as a screw formed from metal or plastic that is screwed into a threaded post hole 20 located in a frame stimulation site region 80. The post tip 30 can be rounded to form an atraumatic contact with the patient's skin; alternately, the post tip 30 can be flat or configured to attach easily to a magnet. The threaded post 10 is able to be adjusted axially perpendicular to the frame frontal surface 65 via rotation of the threaded post 10 to make contact with the contours of a patient's face 40. Other embodiments of the stimulation device 5 provide for angulation of the threaded posts 10 (the posts 10 can swivel at any angle relative to the frontal surface 65 of the frame 25 to accommodate various facial widths 70 and facial lengths 75 of the patient's face 40.

In one embodiment the frame 25 can be formed such that a spring action of the post places the post tip into contact with the patient's skin at all of the stimulation sites 35 to set the depth and location of the threaded posts 10 relative to the stimulation sites 35 on the patient's face. After the axial location of the post tip has been established for a specific patient, the post can be fixed relative to the frame 25 via a locking mechanism (such as a threaded nut or set screw) such that the locations of the post tips 30 make simultaneous contact with the stimulation sites 35.

The frame 25 can be provided in more than one size to fit various patient's faces 40, whether the face 40 is long, short, wide, or narrow. Alternately, the frame 25 can be adjustable via a slotting mechanism or slide to allow the position of the posts 10 to be properly directed in a lateral direction 55 along a person's facial width 70 or in a longitudinal direction 50 along a person's facial length 75. Alternately, the post holes 20 can be angled laterally into the frame 25 or longitudinally into the frame 25 to accommodate variations in the facial width 70 and facial length 75 of a patient's face 40 or varying distances between stimulation sites 35. Further alternately, the post holes 20 can swivel in any direction via a ball and socket configuration as described in subsequent embodiments.

FIGS. 1D, 1E and 1F show an embodiment for the multiple site facial stimulation device 5 of the present invention. The stimulation device 5 is shown having seven frame stimulation site regions 80 to treat multiple stimulation sites on the patient's face although it is understood that the stimulation device 5 can have less than seven frame stimulation site regions 80 or it can have more than seven frame stimulation site regions 80. FIG. 1D shows a frontal view of the frame 25 having seven threaded post holes 20 that allow threaded passage of seven threaded posts 10 that are configured to apply pressure or a normal force 60 via the patient's hand or with a strap, for example, either with the post tips 30 or with magnets 160 (shown in FIG. 3) located at the post tips 30 which are configured for placement adjacent to seven stimulation sites 35. The threaded post holes 20 extend through spherical adjustment balls 105 that are contained within seven spherical sockets 110 forming ball and socket assemblies 117 as shown in a side view in FIG. 1E. Two or more clamping screws 115 hold a first frame portion 120 to a second frame portion 125 and allow assembly of the spherical adjustment balls 105 within the spherical sockets 110. The clamping screws 115 can be loosely tightened to a slight torque to allow for controlled movement of the adjustment balls 105 within the sockets 110 to set the proper angle of the posts 10 to contact multiple stimulation sites 35 simultaneously. Threaded posts 10 contained within the treaded post holes 20 then allow the posts 10 to be angulated (i.e., set at a variable angle relative to the frame frontal surface 65) via the spherical adjustment balls 105 to alter the spacing 130 between post tips 30 in a lateral direction 55 to stimulate stimulation sites 35D and 35D′, for example, to address a narrow or wide face 40. Similarly, the posts 10 can be angulated via the spherical adjustment balls 105 to allow the spacing 130 between post tips 30 in a longitudinal direction 50 to stimulate stimulation sites 35D and 35A, for example, to be altered to address patients with a long face 40 or a shorter longitudinal face 40, for example. The threaded posts 10 can be extended or retracted within the threaded post holes 20 to further alter the location of the post tips 30 to meet the contours of a patient's face. The combination of the ball and socket assembly 117 for the frame 25 and the threaded post holes 20 allows the post tips 30 to individually be adjusted to match the natural contours of the patient's face 40 and place the post tip 30 precisely into intimate contact with the stimulation sites 35 simultaneously to match the location of the stimulation site for any patient regardless of the facial length 75, facial width 70, or contour of their face 40.

As shown in FIGS. 1D and 1E, a set screw 135 can then be tightened into the threaded set screw hole 140 onto the spherical adjustment ball 105 to hold the position of the spherical adjustment ball 105 and the position of the post tip 30 at the proper position such that all post tips 30 are held in place adjacent to the stimulation site. Once all of the stimulation sites 35 are set to match the natural contour and shape of the patient's face 40 and the set screws 135 are tightened, clamping screws 115 that hold a first frame portion 120 to the second frame portion 125 can be tightened to a moderate tightness or torque to further hold the adjustment balls 105 in place and ensure that the position of the post tips 30 against the multiple stimulation sites 30 for a particular patient remains fixed for simultaneous stimulation of multiple stimulation sites 35.

The spherical adjustment balls 105 can be formed from a polymeric material including but not limited to polypropylene, other polyolefins, poly styrene, acrylic, polycarbonate, or other polymer or composite. The frame 25 can similarly be formed from a polymeric material or from other materials capable of being threaded and either molded or machined. The frame 25 can be molded from a polymeric material or it can be machined. The adjustment balls 105 can be molded as two hemispheres or can be molded as a single sphere, the threaded holes through the spherical adjustment balls 105 can be either molded or machined. The frame 25 of this embodiment can be held by the patient's hand and applied to the patient's face 40 using a gentle pressure or normal force 60 to affect a stimulation of the stimulation sites 35.

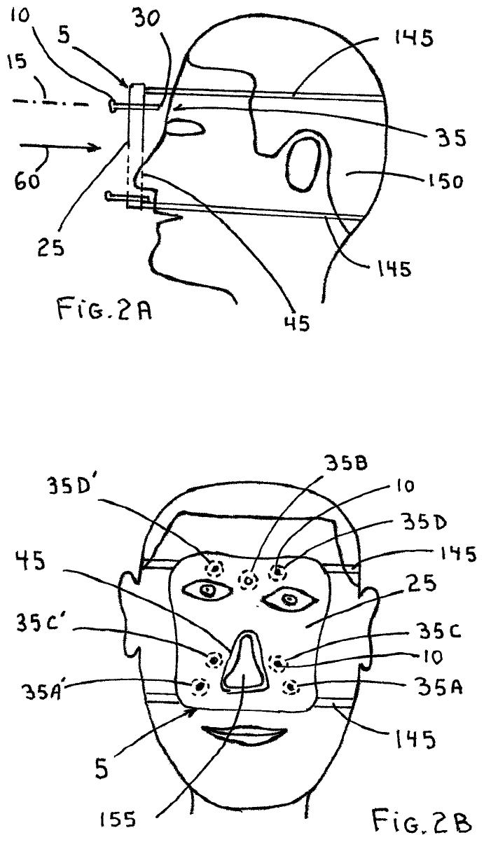

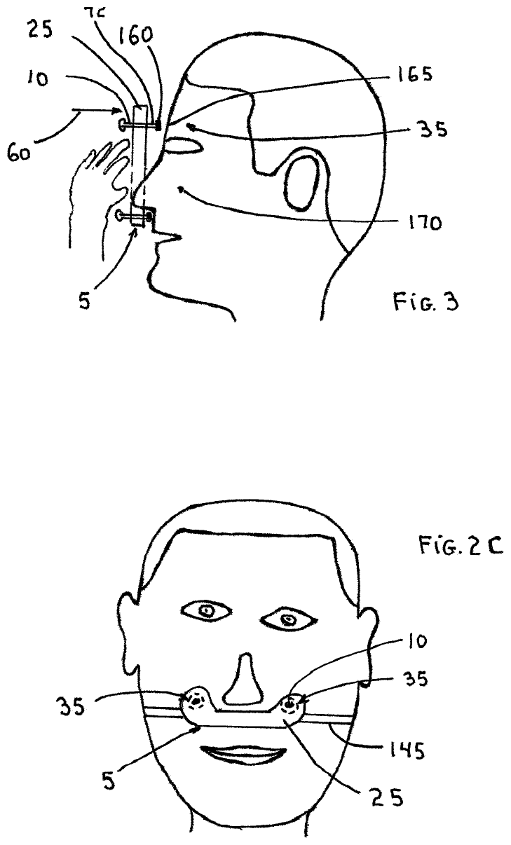

FIGS. 2A, 2B, and 2C show an alternate embodiment for holding a stimulation device 5 with axially adjustable posts 10 movably attached to a frame 25; the stimulation device 5 is held adjacent to the head 150 of a patient via a positional strap or an elastic strap 145. This embodiment is configured to be held to the patient's head 150 for a longer period of time ranging from 10 minutes to overnight or 8 hours. The frame 25 has a nose cut-out 45 that provides placement for a nose 155 of a patient and locates the post tips 30 adjacent to multiple stimulation sites 35 (i.e., 35A, 35A′, 35B, 35C, 35C′, 35D, and 35D′, for example) on the face 40. The tips can be adjusted by the patient to make contact with the multiple stimulation sites 35 (range 2-12 sites) of the face 40 at the same time. The elastic strap 145 can apply a pressure or normal force 60 to the frame 25 to apply pressure toward the multiple stimulation sites 35 simultaneously. FIGS. 2B and 2C show the stimulation device 5 having a frame 25 that makes simultaneous contact with multiple stimulation sites 35 (i.e., 35A, 35A′, 35B, 35C, 35C′, 35D, and 35D′, for example) as described earlier. The normal force 60 applied to each stimulation site is about 4 Oz (range 3-8 Oz). The stimulation device 5 can improve blood flow to the stimulation sites 35, relax the muscle near the stimulation site, cause nerve stimulation, improve lymphatic drainage, reduce the presence of pain, help drain nearby sinus cavities, or in a physiological manner improve air flow through the nasal passages which can enhance sinus drainage.

FIG. 3 shows another embodiment of the present invention having magnets 160 placed at the post tips 30 (see FIG. 2A); an adhesive can be used to adhere a magnet 160 to each of the post tips, for example. Alternately, the magnets 160 can attach to the tip of a ferrous metal post via magnetic attraction, for example. Any of the embodiments of the present invention can have magnets 160 located at the post tips 30. The magnets 160 can be Neodymium, ceramic, or other magnets, for example; each magnet 160 can have a holding force to an iron sheet of about 8 Oz (range 5-16 Oz); the magnetic field of each magnet 160 extends beyond the magnet's contact surface 165 of the magnet 160 with the patient's skin toward the stimulation site 35 below the patient's skin. The magnetic field assists in stimulating the stimulation site even if a normal force 60 is not being applied to the stimulation site. The magnet 160 can provide a magnetic flux density measured in gauss of 3,000 gauss (range 1,000-5,000 gauss). The magnetic flux can penetrate into the tissues and multiple sinus cavities 170 of the head 150 simultaneously to enhance sinus drainage and reduce sinus pressure. Application of either pressure or normal force 60 alone with the present invention or application of a magnet 160 at the post tip with a magnetic flux at multiple sites 35 either with or without normal force 60 to multiple stimulation sites 35 as described in this specification, provides an enhanced benefit for affecting nerve response, reducing sinus pressure, improving circulatory response, improving lymphatic response, and reducing pain.

The stimulation device 5 can have seven posts 10 (range 2-12 posts 10) with magnets 160 located at the post tips 30. The stimulation device 5 that contains magnets 160 can have a similar structure as that shown in any of the previous embodiments and is configured to allow the posts 10 to be axially adjusted to place the magnets 160 into contact with the patient's skin at the stimulation sites 35. The patient can apply pressure or normal force 60 to the frame 25 thereby pressing the magnets 160 into the skin with a normal force 60 ranging from 3-12 Oz for each post. The presence of the magnets 160 can provide a benefit of increase blood flow to the stimulation site, can affect the nerve at the stimulation site, improve lymphatic drainage, reduce pain and inflammation, improve sinus drainage (from sinus cavities 170), or in a physiological manner improve nasal passage air flow during breathing which can enhance sinus drainage. The stimulation device 5 can be applied to the face 40 for a period of about 5 minutes (range 3-15 minutes or more) to obtain the benefit as described that can last up to hours or more. Due to the presence of the magnetic field of the magnet 160, a lower normal force 60 can be applied via the stimulation device 5 to the stimulation sites 35 to obtain the benefits described above.

The frame 25 of the present invention can have one or more positional straps 145 that hold the frame 25 to the patient's head 150. The posts 10 can have magnets 160 attached to the tip in a manner similar to that described in FIG. 3. The posts 10 are adjusted such that each of the magnets 160 makes contact with the patient's skin at each of the stimulation sites 35. The normal force 60 of the magnets 160 against the skin can be very small and can just make contact with zero normal force 60 (force 60 ranges from zero to about 5 Oz). The zero normal force 60 contact with the facial skin allows the magnet 160 to be placed comfortably against the skin overnight without the use of adhesives against the skin. The simultaneous stimulation of multiple stimulation sites 35 can provide effective treatment by increasing blood flow, decrease muscle spasm, improve lymphatic drainage, influence the nerve at the stimulation site, reducing the presence of pain, increasing drainage of the sinus cavity 170, or in a physiological manner improving the nasal airway passages for improved breathing and enhanced sinus drainage.

Common reference numerals used throughout the specification and drawings for various embodiments describe structural elements that have the same description. Structural elements found in one embodiment can be applied to other embodiments and understood to be included within the present invention. Any of the embodiments presented can contain any of the features found in any other of the embodiments found in the present invention.

1. A device for providing simultaneous stimulation of multiple stimulation sites on a face of a patient comprising;
A. a frame configured for placement adjacent to the face of the patient, said frame having two or more posts adjustably connected thereto, each of said two or more posts being directed toward each of the multiple stimulation sites, said two or more posts being configured to make contact with the multiple stimulation sites simultaneously along a contour of the face,
B. said frame being configured to have a normal force applied thereto towards the multiple stimulation sites, said normal force being transmitted via said two or more posts to the multiple stimulation sites simultaneously.

2. The device of claim 1 wherein at least one of said two or more posts are directed perpendicular to a frontal surface of said frame,

3. The device of claim 1 wherein at least one of said two or more posts are directed at a lateral or longitudinal angle relative to a frontal surface of said frame.

4. The device of claim 1 wherein at least one of said two or more posts are directed at a variable angle relative to a frontal surface of said frame via an angulation assembly.

5. The device of claim 1 wherein a nasal cut-out or open space in said frame provides lateral and longitudinal positioning of said frame relative to the face of the patient.

6. The device of claim 1 wherein said frame is adapted to provide said normal force being placed onto each of the multiple stimulation sites of at least 3 Oz.

7. The device of claim 1 wherein said normal force is being placed for at least 3 minutes.

8. The device of claim 1 further comprising at least one strap attached to said frame, said strap being configured to extend around a head of the patient, said strap being configured to hold said frame adjacent to the face of the patient and provide said normal force to each of the multiple stimulation sites of at least 3 Oz.

9. The device of claim 1 further comprising two or more magnets, each of said two or more magnets being located on each of said two or more posts, said two or more magnets being placed into contact with said multiple stimulation sites, each of said two or more magnets adapted to provide said normal force to said stimulation sites simultaneously.

10. The device of claim 9 wherein said normal force applied by said two or more magnets onto each of the multiple stimulation sites is zero force.

11. The device of claim 9 wherein said normal force being applied by each of said two or more magnets onto each of the multiple stimulation sites is at least 3 Oz.

12. The device of claim 9 wherein a magnetic strength of each of said two or more magnets is able to apply a release force of at least 5 Oz from an iron plate.

13. The device of claim 9 wherein each of said two or more magnets has a magnetic flux density of at least 1000 gauss.

14. The device of claim 9 wherein each of said two or more magnets provides a magnetic flux density of at least 3,000 gauss.

15. The device of claim 9 further comprising a strap, said strap being configured to extend around the head of the patient, said strap configured to hold each of said two or more magnets into contact with each of the multiple stimulation sites at zero force.

16. The device of claim 9 further comprising a strap, said strap being configured to extend around the head of the patient, said strap configured to hold each of said two or more magnets into contact with each of the multiple stimulation sites at a force of up to 5 Oz.

17. A device for providing simultaneous stimulation on a face of a patient at multiple stimulation sites comprising;
A. a frame configured to position two or more posts relative to a face of the patient, said frame providing lateral and longitudinal positioning of said two or more posts adjacent to the multiple stimulation sites,
B. said two or more posts being adjustably connected to said frame, each of said two or more posts being configured to be initially positioned into simultaneous contact with the multiple stimulation sites without a normal force,
C. said frame being adapted for placement of a normal force onto said frame and transmitting said normal force to each of the multiple stimulation sites simultaneously via contact of said two or more posts with each of the multiple stimulation sites.

18. A device for providing stimulation on a face of a patient at multiple stimulation sites comprising;
A. a frame configured to position two or more posts adjacent to the multiple stimulation sites,
B. said two or more posts being adjustably connected to said frame in an axial direction toward the multiple stimulation sites, each of said two or more posts having a magnet that is positioned thereon, said magnets being configured to make contact with each of the multiple stimulation sites simultaneously,
C. said frame being adapted to place a normal force via said two or more posts onto each of the multiple stimulation sites simultaneously.

19. The device of claim 18 wherein said normal force being applied to the multiple stimulation sites is zero.

20. The device of claim 18 wherein said normal force being applied to each of the multiple stimulation sites is less than 12 oz.
